(19) United States
(12) Patent Application Publication
(10) Pub. No.: US 2016/0163442 A1
(43) Pub. Date: Jun. 9, 2016

(54) ELECTRONIC COMPONENT

(71) Applicant: SAMSUNG ELECTRO-MECHANICS CO., LTD., Suwon-Si (KR)

(72) Inventors: Chan YOON, Suwon-Si (KR); Dong Hwan LEE, Suwon-Si (KR); Young Ghyu AHN, Suwon-Si (KR)

(21) Appl. No.: 14/925,535

(22) Filed: Oct. 28, 2015

(30) Foreign Application Priority Data
Dec. 8, 2014 (KR) 10-2014-0175265

(51) Int. Cl. H01F 27/00; H01F 27/24; H01F 27/28

(52) U.S. Cl. CPC H01F 27/008; H01F 27/2804; H01F 27/24; H01F 2027/2809

(57) ABSTRACT

An electronic component comprises a magnetic body containing a magnetic metal powder; and internal coil parts embedded in the magnetic body and disposed on one surface and the other surface of an insulating substrate, respectively. A core part is disposed inwardly of the internal coil parts, and a through-hole penetrating through the magnetic body is disposed in a portion of the core part.

### CROSS-REFERENCE TO RELATED APPLICATION

This application claims the benefit of priority to Korean Patent Application No . 10-2014-0175265 filed on Dec. 8, 2014, with the Korean Intellectual Property Office, the disclosure of which is incorporated herein by reference.

### BACKGROUND

The present disclosure relates to an electronic component.

An inductor, an electronic component, is a representative passive element configuring an electronic circuit together with a resistor and a capacitor to remove noise therefrom.

A thin-film inductor is commonly manufactured by forming internal coil parts, hardening a magnetic powder-resin composite in which a magnetic powder and a resin are mixed to manufacture a magnetic body, and forming external electrodes on external surfaces of the magnetic body.

### SUMMARY

An aspect of the present disclosure may provide an electronic component having an improved heat radiation function.

According to an aspect of the present disclosure, an electronic component may include: a magnetic body in which internal coil parts are embedded, a core part formed internally of the internal coil parts, and a through-hole disposed in the core part and penetrating through the magnetic body.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating an electronic component according to an exemplary embodiment in the present disclosure;

FIG. 2 is a perspective view illustrating a magnetic body including internal coil parts in the electronic component according to an exemplary embodiment in the present disclosure;

FIG. 3 is a diagram illustrating distribution of magnetic flux formed in the electronic component;

FIG. 4 is a plan view illustrating internal coil parts in the electronic component according to an exemplary embodiment in the present disclosure;

FIG. 5 is a graph illustrating changes in inductance and I_{RMS} depending on a ratio of a diameter d of a through-hole to a width W of the magnetic body;

FIGS. 6A and 6B are plan views illustrating internal coil parts in an electronic component according to another exemplary embodiment in the present disclosure;

FIG. 7A is a perspective view illustrating a magnetic body including internal coil parts in an electronic component according to another exemplary embodiment in the present disclosure, and FIG. 7B is a plan view illustrating the internal coil parts in the electronic component of FIG. 7A; and

FIG. 8 is a graph illustrating changes in inductance and I_{RMS} depending on a ratio of an area Aₕₒₗₑ of a cross section of a through-hole to an area A_{LW} of a cross section of the magnetic body in a length-width (LW) direction.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Electronic Component

Hereinafter, an electronic component according to an exemplary embodiment in the present disclosure, particularly, a thin-film inductor, will be described. However, the electronic component according to an exemplary embodiment in the present disclosure is not necessarily limited thereto.

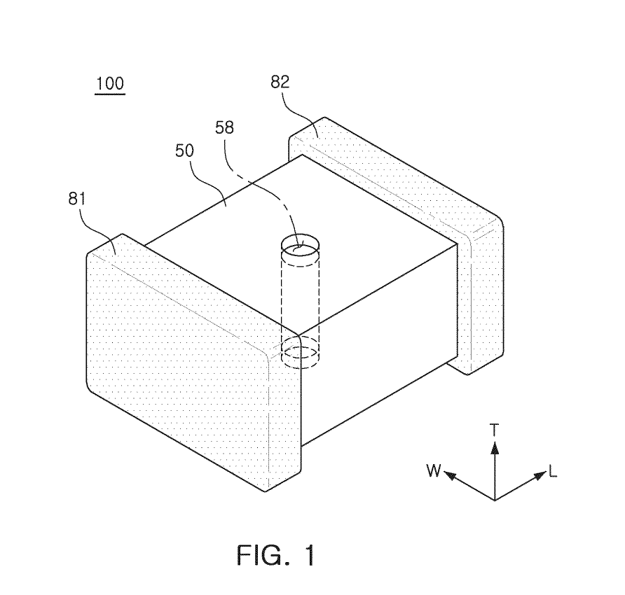

FIG. 1 is a perspective view schematically illustrating an electronic component according to an exemplary embodiment in the present disclosure.

Referring to FIG. 1, the electronic component 100 according to an exemplary embodiment in the present disclosure may include a magnetic body 50, a through-hole 58 penetrating through the magnetic body 50, and first and second external electrodes 81 and 82 disposed on external surfaces of the magnetic body 50.

In the electronic component 100 according to an exemplary embodiment in the present disclosure, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

According to an exemplary embodiment in the present disclosure, the through-hole 58 penetrating through the magnetic body 50 may be formed to increase a surface area of the magnetic body contacting ambient air, thereby improving heat radiation characteristics.

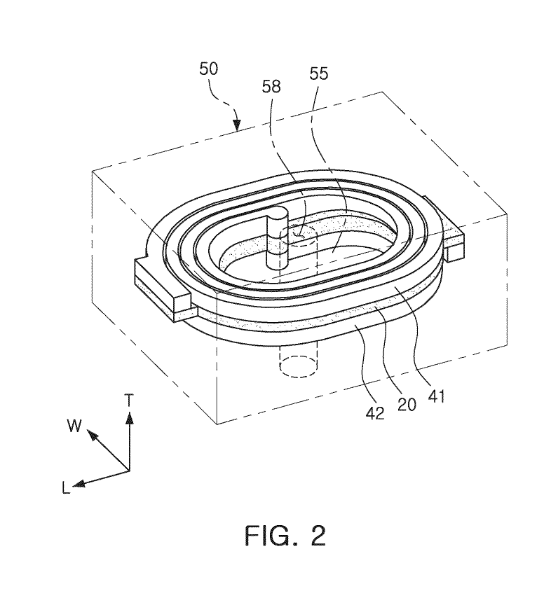

FIG. 2 is a perspective view illustrating a magnetic body including internal coil parts in the electronic component according to an exemplary embodiment in the present disclosure.

In FIG. 2, an internal structure of a thin-film inductor used in a power line of a power supplying circuit is illustrated as an example of the electronic component.

The magnetic body 50 of the electronic component 100 according to an exemplary embodiment in the present disclosure may include internal coil parts 41 and 42.

A first internal coil part 41 having a planar coil form may be formed on one surface of an insulating substrate 20 disposed in the magnetic body 50, and a second internal coil part 42 having a planar coil form may be formed on the other surface of the insulating substrate 20 opposing one surface of the insulating substrate 20 on which the first internal coil part 41 is provided.

The first and second internal coil parts 41 and 42 may be formed on the insulating substrate 20 using an electroplating process, but are not necessarily limited thereto.

The first and second internal coil parts 41 and 42 may have spiral shapes, and the first and second internal coil parts 41 and 42 formed on one surface and the other surface of the insulating substrate 20, respectively, may be electrically connected to each other by a via (not illustrated) penetrating through the insulating substrate 20.

The first and second internal coil parts 41 and 42 and the via may be formed to contain a metal having excellent electrical conductivity, for example, silver (Ag), palladium (Pd), aluminum (Al), nickel (Ni), titanium (Ti), gold (Au), copper (Cu), platinum (Pt), or alloys thereof.

One end portion of the first internal coil part 41 formed on one surface of the insulating substrate 20 may be exposed to one end surface of the magnetic body 50 in the length (L) direction thereof, and one end portion of the second internal coil part 42 formed on the other surface of the insulating substrate 20 may be exposed to the other end surface of the magnetic body 50 in the length (L) direction thereof.

However, one end portion of each of the first and second internal coil parts 41 and 42 is not limited to being exposed as described above, but may be exposed to at least one surface of the magnetic body 50.

The first and second external electrodes 81 and 82 may be formed on the external surfaces of the magnetic body 50 to be connected, respectively, to the first and second internal coil parts 41 and 42 exposed to the end surfaces of the magnetic body 50.

The magnetic body 50 may contain a magnetic metal powder. However, the magnetic body 50 is not limited to containing the magnetic metal powder, but may contain any magnetic powder exhibiting magnetic characteristics.

The magnetic metal powder may be a powder of a crystalline or amorphous metal containing one or more selected from the group consisting of iron (Fe), silicon (Si), boron (B), chrome (Cr), aluminum (Al), copper (Cu), niobium (Nb), and nickel (Ni).

For example, the magnetic metal powder may include a powder of Fe—Si—B—Cr-based spherical amorphous metal.

The magnetic metal powder may be contained in a thermosetting resin such as epoxy, polyimide, or the like, in a form in which the magnetic metal powder is dispersed in the thermosetting resin.

The magnetic body 50 may be manufactured by stacking a plurality of magnetic sheets on upper and lower surfaces of the first and second coil internal parts and then compressing and hardening the plurality of magnetic sheets.

The magnetic sheets may be manufactured by mixing a magnetic metal powder, a thermosetting resin, and organic materials such as a binder, a solvent, and the like, with each other to prepare a slurry, and applying the slurry to carrier films using a doctor blade method at a thickness of several tens of pm and then drying the slurry.

The magnetic sheets may be stacked, compressed using a laminate method or an isostatic press method, and then hardened to form the magnetic body 50.

The first and second internal coil parts 41 and 42 may be coated with an insulating layer (not illustrated) so as not to directly contact the magnetic metal powder forming the magnetic body 50.

The insulating layer (not illustrated) may be formed using a method well-known in the art such as a screen printing method, an exposure and development method of a photo-resist (PR), a spray applying method, or the like.

A core part 55 may be formed inwardly of the internal coil parts 41 and 42.

The core part 55 may be filled with magnetic metal powder to improve inductance L.

To form the core part 55, a portion of the insulating substrate 20 on which the first and second internal coil parts 41 and 42 have not been formed may first be removed, and then the magnetic sheets may be stacked on lower and upper surfaces of the insulating substrate 20 and may be compressed such that a magnetic material may be filled in the core part 55.

The through-hole 58 penetrating through the magnetic body 50 may be disposed in a portion of the core part 55.

The through-hole 58 may be disposed in a direction perpendicular to the internal coil parts 41 and 42 having the planar coil form.

The through-hole 58 may not be filled with the magnetic metal powder, and be provided as an empty space.

When a direct current (DC) current flows to the internal coil parts, heat may be generated due to resistance of the internal coil parts. In addition, when an alternating current (AC) current flows to the internal coil parts, heat may be generated due to a skin effect or loss of the magnetic material.

The heat generated as described above may damage the insulating layer coating the internal coil parts, and may generate a defect such as a short-circuit between coils. In addition, in a case in which a temperature of the magnetic material rises, magnetic characteristics may be rapidly deteriorated, and inductance L may be rapidly decreased.

Thus, according to an exemplary embodiment in the present disclosure, the through-hole 58 may be formed to increase the surface area of the magnetic body 50 contacting the ambient air, thereby improving heat radiation characteristics.

Accordingly, a defect, such as a short-circuit, between coils occurring due to damage to the insulating layer may be prevented, and a decrease in the inductance L occurring due to a rise in a temperature of the electronic component may be prevented.

The through-hole 58 may be formed by forming the magnetic body 50 and then performing mechanical drilling, laser drilling, sand blasting, punching, or the like, on the core part 55 of the magnetic body 50.

Alternatively, to form the through-hole 58 penetrating through the magnetic body 50, through-holes may first be formed in a plurality of magnetic sheets, and then the plurality of magnetic sheets may be stacked so that the through-holes form a single axis, at the time of forming the magnetic body.

However, the through-hole 58 is not necessarily limited to being formed using the above-mentioned methods, but may be formed using any method that may implement an effect of the present disclosure.

The through-hole 58 according to an exemplary embodiment in the present disclosure may be disposed in a central portion of the core part 55.

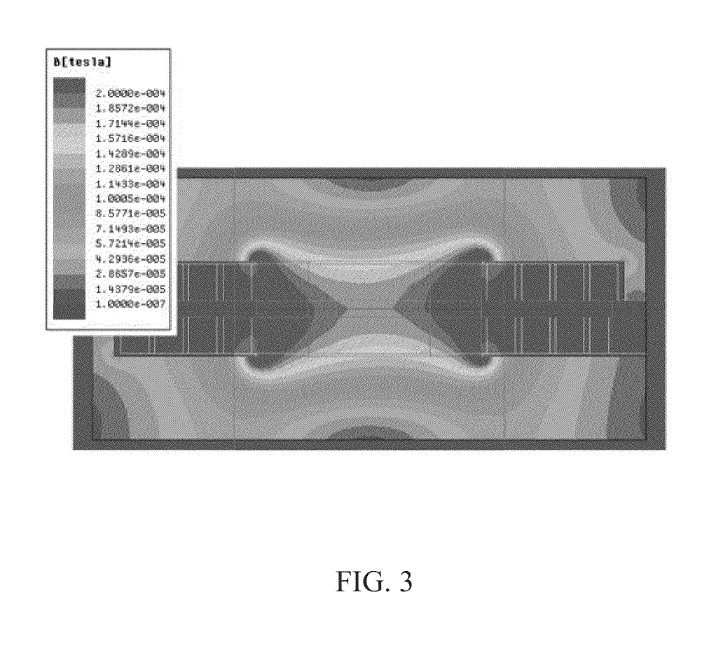

FIG. 3 is a diagram illustrating distribution of magnetic flux formed in the electronic component.

Referring to FIG. 3, the amount of magnetic flux formed in a central portion of the core part 55 formed inwardly of the internal coil parts 41 and 42 is smaller than that of magnetic flux formed in portions of the core part 55 adjacent to the internal coil parts 41 and 42.

Therefore, according to an exemplary embodiment in the present disclosure, the through-hole 58 may be disposed in the central portion of the core part 55 to improve the heat radiation characteristics and significantly suppress the decrease in the inductance L.

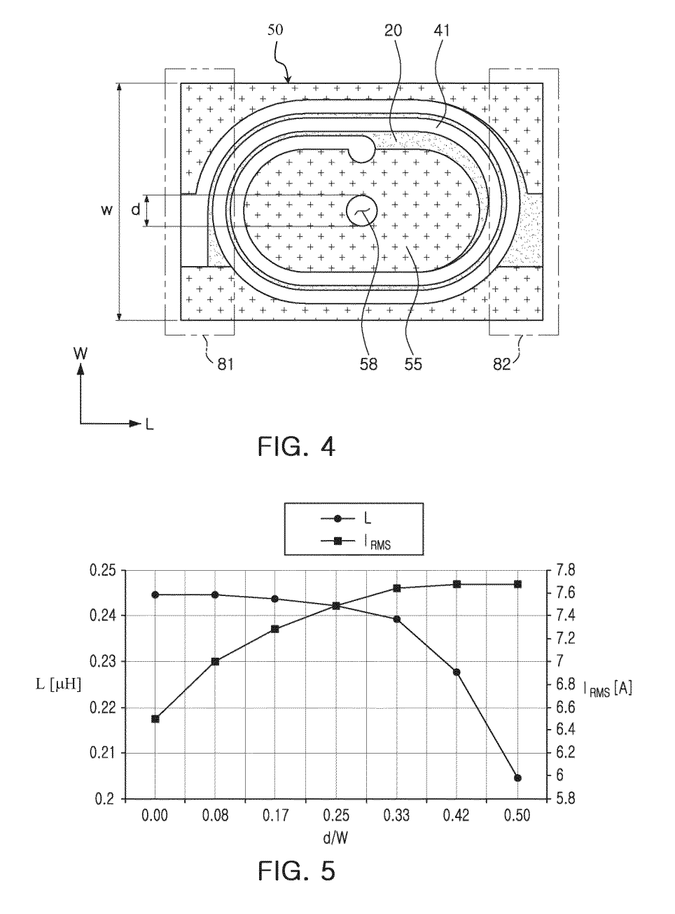

FIG. 4 is a plan view illustrating the internal coil parts in the electronic component according to an exemplary embodiment in the present disclosure.

Referring to FIG. 4, in the electronic component 100 according to an exemplary embodiment in the present disclosure, the core part 55 may be formed inwardly of the internal coil part 41, and the through-hole 58 may be disposed in the central portion of the core part 55.

The through-hole 58 may be provided as an empty space, and a portion of the core part 55 other than the through-hole 58 may be filled with a magnetic metal powder.

When an area of a cross section of the magnetic body 50 in a length-width (LW) direction thereof is A_{LW}, and an area of a cross section of the through-hole 58 is Aₕₒₗₑ, 0.02≦Aₕₒₗₑ/A_{LW} 0.25 may be satisfied.

In a case in which Aₕₒₗₑ/A_{LW} is less than 0.2, an increase in a surface area of the magnetic body 50 contacting the ambient air may be relatively small, such that a heat radiation effect may be very low, and in a case in which Aₕₒₗₑ/A_{LW} exceeds 0.25, a volume of the magnetic material filled in the core part 55 may be excessively decreased, such that inductance L may be significantly decreased.

Meanwhile, as illustrated in FIG. 4, in a case in which the cross section of the through-hole 58 has a circular shape, when a width of the magnetic body 50 is W and a width of the through-hole 58 is d, 0.08≦d/W≦0.33 may be satisfied.

In a case in which d/W is less than 0.08, an increase in a surface area of the magnetic body 50 contacting the ambient air may be small, such that a heat radiation effect may be very low, and in a case in which d/W exceeds 0.33, a volume of the magnetic material filled in the core part 55 may be excessively decreased, such that inductance L may be significantly decreased.

Although the through-hole 58 has been illustrated as having a cylindrical shape in FIGS. 2 and 4, the through-hole 58 is not necessarily limited to having the cylindrical shape, but may have any shape in a range utilizable by those skilled in the art as long as it may increase the surface area of the magnetic body contacting the ambient air to improve the heat radiation characteristics.

FIG. 5 is a graph illustrating changes in inductance and I depending on a ratio of a diameter d of a through-hole to a width W of the magnetic body.

FIG. 5 illustrates resultant values obtained while changing the diameter d of the through-hole having a circular cross section in the length-width (LW) direction of the magnetic body as in the exemplary embodiment illustrated in FIG. 4.

I_{RMS} is a current value when a temperature of the electronic component rises from 25° C., room temperature, by 40° C. That is, I_{RMS} is a current value in a case in which a temperature of the electronic component arrives at 65° C. when a current is increased from 0A. The larger I_{RMS} value means that the heat radiation characteristics of the electronic component are more excellent.

Referring to FIG. 5, when 0.08≦d/W≦0.33 is satisfied, a decrease in the inductance L is small and an increase rate in I_{RMS} is large. In a case in which d/W exceeds 0.33, a decrease in the inductance L may be large, but an increase rate in I_{RMS} may be decreased.

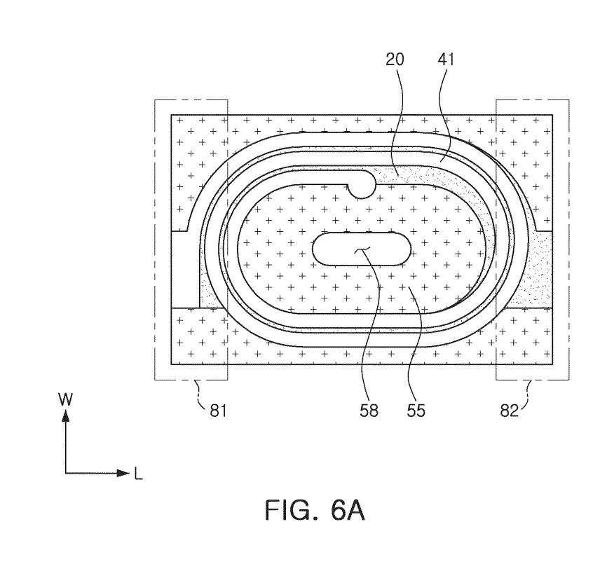

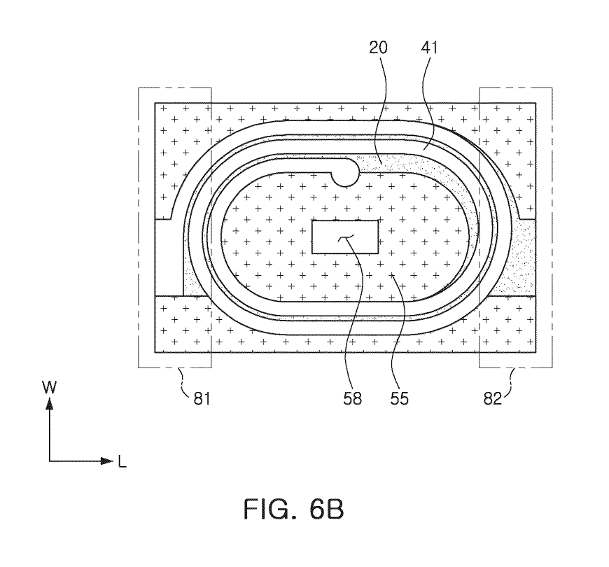

FIGS. 6A and 6B are plan views illustrating internal coil parts in an electronic component according to another exemplary embodiment in the present disclosure.

Referring to FIG. 6A, according to another exemplary embodiment in the present disclosure, a cross section of the through-hole 58 in the length-width (LW) direction thereof may have an elliptical shape.

Referring to FIG. 6B, according to another exemplary embodiment in the present disclosure, a cross section of the through-hole 58 in the length-width (LW) direction of the magnetic body 50 may have a quadrangular shape.

As described above, the through-hole 58 may have any one of, for example, a cylindrical shape, an elliptical pillar shape, and a quadrangular pillar shape.

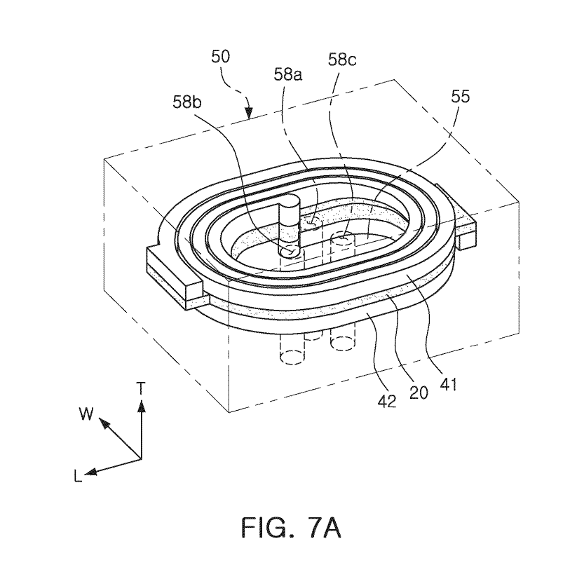

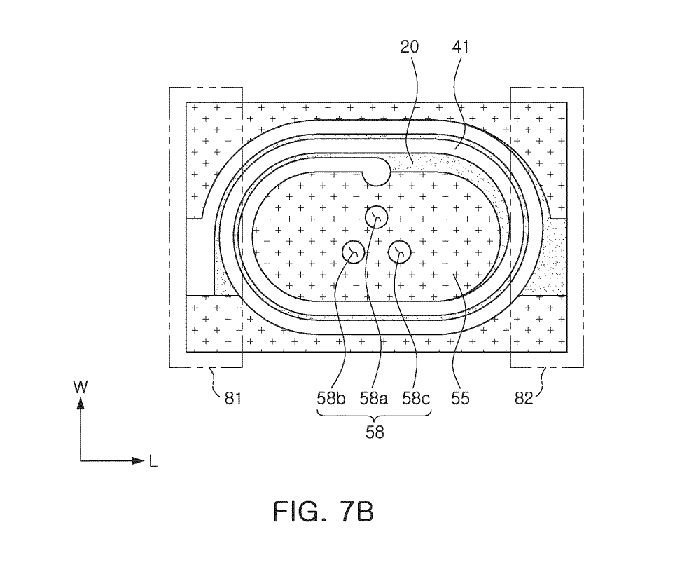

FIG. 7A is a perspective view illustrating internal coil parts in a magnetic body of an electronic component according to another exemplary embodiment in the present disclosure, and

FIG. 7B is a plan view illustrating the internal coil parts in the electronic component of FIG. 7A.

Referring to FIG. 7A, the electronic component according to another exemplary embodiment in the present disclosure may include a plurality of through-holes 58a, 58b, and 58c penetrating through the magnetic body 50.

Although three through-holes 58a, 58b, and 58c having a cylindrical shape have been illustrated in FIG. 7A, the through-holes 58a, 58b, and 58c are not necessarily limited to having the cylindrical shape, but may have any structure that may be utilized by those skilled in the art as long as they may implement an effect of the present disclosure.

Referring to FIG. 7B, the plurality of through-holes 58a, 58b, and 58c may be disposed in the central portion of the core part 55.

Since magnetic flux in the central portion of the core part 55 is smaller than magnetic flux in portions of the core part 55 adjacent to the internal coil parts 41 and 42, the plurality of through-holes 58a, 58b, and 58c may be disposed in the central portion of the core part 55, thereby improving heat radiation characteristics and significantly suppressing a decrease in the inductance L.

In a case in which the plurality of through-holes 58a, 58b, and 58c are formed, when an area of a cross section of the magnetic body 50 in the length-width (LW) direction thereof is A_{LW} and a sum of areas of cross sections of the through-holes 58a, 58b, and 58c in the length-width (LW) direction of the magnetic body 50 is Aₕₒₗₑ, 0.02≦Aₕₒₗₑ/A_{LW}≦0.25 may be satisfied.

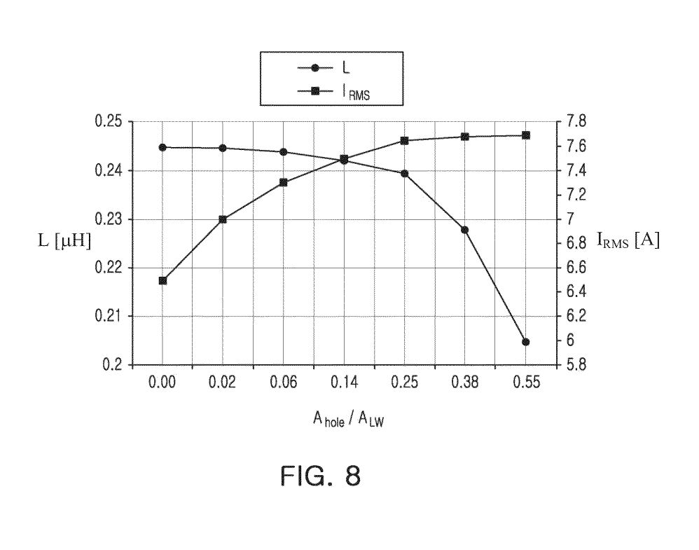

FIG. 8 is a graph illustrating changes in inductance and I_{RMS} depending on a ratio of an area Aₕₒₗₑ of a cross section of a through-hole to an area A_{LW} of a cross section of the magnetic body in a length-width (LW) direction thereof.

Referring to FIG. 8, when 0.02≦Aₕₒₗₑ/A_{LW}≦0.25 is satisfied, a decrease in the inductance L is small and an increase rate in I_{RMS} is large. In a case in which Aₕₒₗₑ/A_{LW} exceeds 0.25, a decrease in the inductance L may be large, but an increase rate in I_{RMS} may be decreased.

As set forth above, according to exemplary embodiments in the present disclosure, heat generated when a current is applied to the electronic component may be effectively radiated.

While exemplary embodiments have been shown and described above, it will be apparent to those skilled in the art that modifications and variations could be made without departing from the scope of the present invention as defined by the appended claims.

What is claimed is:

1. An electronic component comprising:
a magnetic body in which internal coil parts are embedded;
a core part formed inwardly of the internal coil parts; and
the core part having a through-hole disposed therein and penetrating through the magnetic body.

2. The electronic component of claim 1, wherein the through-hole is disposed in a central portion of the core part.

3. The electronic component of claim 1, wherein the through-hole is disposed perpendicularly with respect to the internal coil parts.

4. The electronic component of claim 1, wherein the through-hole has any one of a cylindrical shape, an elliptical pillar shape, and a quadrangular pillar shape.

5. The electronic component of claim 1, wherein the through-hole comprises a plurality of through-holes.

6. The electronic component of claim 1, wherein 0.02 ≦Aₕₒₗₑ/A_{LW}<0.25 is satisfied, in which A_{LW} is an area of a cross section of the magnetic body in a length-width direction thereof and Aₕₒₗₑ is an area of a cross section of the through-hole in the length-width direction.

7. The electronic component of claim 1, wherein 0.08≦d/W≦0.33 is satisfied, in which W is a width of the magnetic body and d is a width of the through-hole.

8. The electronic component of claim 1, wherein the magnetic body contains a magnetic metal powder.

9. The electronic component of claim 1, wherein the through-hole is provided as an empty space.

10. The electronic component of claim 1, wherein a portion of the insulating substrate on which the internal coil parts is not formed is filled with a magnetic material for forming the core part.

11. An electronic component comprising:
a magnetic body containing a magnetic metal powder; and
internal coil parts embedded in the magnetic body and disposed on one surface and the other surface of an insulating substrate, respectively,
wherein a core part is disposed inwardly of the internal coil parts, and a portion of the core part contains a through-hole penetrating through the magnetic body.

12. The electronic component of claim 11, wherein the through-hole is provided as an empty space.

13. The electronic component of claim 11, wherein a portion of the core part other than the through-hole is filled with the magnetic metal powder.

14. The electronic component of claim 11, wherein the through-hole is disposed in a central portion of the core part.

15. The electronic component of claim 11, wherein 0.02≦Aₕₒₗₑ/A_{LW}0.25 is satisfied, in which A_{LW} is an area of a cross section of the magnetic body in a length-width direction thereof and Aₕₒₗₑ is an area of a cross section of the through-hole in the length-width direction thereof.

16. The electronic component of claim 11, wherein 0.08≦d/W≦0.33 is satisfied, in which W is a width of the magnetic body and d is a diameter of the through-hole in a length-width direction.

17. The electronic component of claim 11, wherein a portion of the insulating substrate on which the internal coil parts is not formed is filled with the magnetic metal powder for forming the core part.
